(19) United States
(12) Patent Application Publication
(10) Pub. No.: US 2015/0178464 A1
(43) Pub. Date: Jun. 25, 2015

(54) INSTRUMENT AND METHOD FOR ASSESSING SYMPTOMS OF VENOUS INSUFFICIENCY

(71) Applicant: DAVID DAKIN IORWERTH WRIGHT, Henley on Thames (GB)

(72) Inventor: DAVID DAKIN IORWERTH WRIGHT, Henley on Thames (GB)

(21) Appl. No.: 14/555,154

(22) Filed: Nov. 26, 2014

Related U.S. Application Data
(60) Provisional application No. 61/908,958, filed on Nov. 26, 2013.

(51) Int. Cl. G06F 19/00

(52) U.S. Cl. CPC G06F 19/3431; G06F 19/363

(57) ABSTRACT

The method of determining eligibility for seeking medical intervention to treat venous insufficiency. An individual is presented with a group of questions relating to varicose veins and an output score is calculated based on the individual's answer and the predetermined weight of the question. The output score is analyzed to determine the individual's eligibility for medical intervention.

### FIELD OF THE INVENTION

This invention relates to instruments, devices and questionnaires which assess symptoms associated with venous insufficiency, including varicose veins, and to methods for assessing severity of venous insufficiency. Such methods may be used to screen patient eligibility for treatment, to monitor efficacy of treatments and/or to predict efficacy of a proposed treatment.

### BACKGROUND OF THE INVENTION

Varicose veins are extremely common, affecting up to 25% of the adult population; in the United States alone, more than 30 million adults over 40 years old have varicose veins, with women twice as likely as men to develop varicosities. Varicose veins are thus a real medical concern that often require treatment.

Varicose veins develop secondary to vein valve failure (incompetence) of one or more valves separating the deep venous system from the superficial venous system. The superficial venous system includes the great and small saphenous veins (GSV and SSV) and their tributaries. The most common clinical presentation of superficial venous incompetence is failure of the terminal (proximal) valve of the great saphenous vein (GSV), located at the saphenofemoral junction (SFJ) in the groin.

If the SFJ valve fails, blood flows abnormally from proximal to distal under the influence of gravity when the patient is standing or sitting. This reversal of the normal direction of venous blood flow is known as “reflux”. This leads to the transmission of elevated hydrostatic venous pressure down the leg. Where there is further failure of the venous valves between the distal GSV and one or more tributary veins lying just beneath the skin the result is the progressive dilation and elongation of the superficial veins and the well-known appearance of varicose veins. The unsightly nature of visible varicose veins is characterized by several features, including bulging and tortuosity.

The extent and aesthetic severity of the visible varicosities varies greatly and is not necessarily linked to the severity of clinical symptoms of the disease. Most of the symptoms are directly explicable by venous hypertension. There is dilation of the vein wall which gives a sensation of tension, and the vein may be tender to touch. Edema forms during the course of the day, resulting in a number of symptoms, such as tightness in the leg and swelling. The most common patient-reported symptoms for varicose veins include heavy legs, aching, swelling, night cramps, restlessness, heat or burning sensation, throbbing, itching, tingling sensation and pain. These symptoms are frequently the cause of absenteeism at work, disability and decreased quality of life.

The presence and importance of symptoms of venous incompetence can only be evaluated using direct feedback from the patient through a patient-reported outcome (PRO) measure. Currently, there is a lack of consensus regarding the best way to measure symptoms of varicose veins and chronic venous disease as evidenced by the wide range of instruments used in previous studies Possibly the most widely-used measure of the impact chronic vascular disorders of the leg is the VEINES-QOL/Sym (Lamping, D. L., Schroter, S., Kurz, X., Kahn, S. R., & Abenhaim, L. (2003) Evaluation of outcomes in chronic venous disorders of the leg: development of a scientifically rigorous, patient-reported measure of symptoms and quality of life, J Vasc. Surg., 37: 410-419) that was developed as part of the Venous Insufficiency Epidemiology Study (VEINES). The VEINES-QOL/Sym has been evaluated in a number of studies, and the instrument measures quality of life and symptoms related to a wide range of chronic venous disorders of the leg. However, given the broad nature of chronic vascular disorders captured by the instrument, the breadth of symptoms and QOL domains, and the use of a four-week recall period, the VEINES-QOL/Sym is not specific enough or adequately responsive to changes in symptoms reported by patients treated for superficial venous incompetence. The use of such PRO measures as a means to properly assess symptoms and to monitor or predict efficacy of treatment is thus inherently variable and difficult without further interpretation, analysis or clinical assessment by a clinician or other professional.

A standardised instrument or process by which common symptoms of varicose veins can be assessed, without the involvement of a clinician, is highly desirable. Such an instrument would be also be very useful for clinician and lay persons alike in assessing varicose vein symptoms in a more objective manner, such that they could be screened in or out of particular treatment regimens and that efficacy of a chosen treatment can be predicted and monitored.

### SUMMARY OF THE INVENTION

Accordingly the present invention provides a method of determining eligibility for seeking medical intervention for the treatment of venous insufficiency comprising:
presenting a group of questions to an individual wherein each of said questions relate to one or more symptoms of varicose veins and wherein each question is assigned a predetermined weight;
providing a platform for the individual to answer the group of questions; calculating an output score based on the individual's answers to each of the questions and the predetermined weight of the question;
analysing said output score to determine an eligibility of the individual for medical intervention; and
presenting the individual on the platform the individual's eligibility for medical intervention.

Accordingly the present invention provides a method of indicating to an individual potentially suffering from venous insufficiency, that they should seek diagnosis or treatment from a physician for venous insufficiency comprising
presenting a series of questions to the individual relating to one or more symptoms of varicose veins wherein each question has a score;
recording the patients answers to said questions;
calculating the total score based on the patients answers;
determining if the total score is greater than x;
if the score is greater than x, indicating to the individual they should seek diagnosis or treatment from a physician; and
if the score is less than x, indicating to the individual they should not seek diagnosis or treatment from the physician.

Accordingly the present invention provides an internet based method for use by an individual to determine eligibility for treatment of venous insufficiency comprising providing on an internet site a group of questions to the individual wherein each of said questions relate to one or more symptoms of varicose veins and wherein each question is assigned a predetermined weight;
collecting the individual's answers to the group of questions and calculating an output score based on the individual's answers to each of the questions and the predetermined weight of the question;
applying an algorithm to determine an eligibility score based on the output score; and displaying a recommended course of action for the treatment of venous insufficiency based on the eligibility score; and
displaying a list of physicians that may provide the individual with treatment.

Accordingly the present invention provides a method of determining eligibility for seeking medical intervention for the treatment of venous insufficiency comprising:
administering one or more questions to an individual wherein said questions relate to symptoms of varicose veins;
collecting the answers to said questions;
assigning an individual score to each of said questions;
calculating an output score from the individual score; and
analysing said output score to determine eligibility for medical intervention.

The questions can relate to the duration of varicose vein symptoms. The questions can relate to the intensity of varicose vein symptoms over a defined period of time. The symptoms of varicose veins are selected from the group consisting of “heaviness”, “achiness”, “swelling”, “throbbing”, “itching”, “heat or burning sensation”, “tingling sensation”, “night cramps” and “restless legs.” At least 4, preferably 5, of the symptoms of varicose veins are selected for the methods. The answers to the questions can be collected on paper.

The individual scores can range from 0 to 10. The of the output score can be additive. The method of analysis of the output score to determine eligibility for medical intervention can compare the output score with a predetermined range such that output scores falling within the range are deemed eligible for seeking treatment.

The steps of any of the disclosed methods can be performed on a portable electronic device. The administering step can include a prompt to the individual to answer the questions. The prompting can occur at a pre-scheduled time.

The steps of any of the methods can be repeated daily the individual scores can be averaged over a five day or a seven day period.

Accordingly the present invention provides a method of recording a change in varicose vein symptom intensity over a period of time, said method comprising:
(a) administering one or more questions to an individual wherein said questions relate to symptoms of varicose veins;
(b) collecting the answers to said questions;
(c) assigning an individual score to each of said questions;
(d) calculating an output score from the individual score;
   wherein steps (a) to (d) are completed at a first time point and
(e) repeating steps (a) to (d) at a second, predetermined time point which is at least one day after the first time point; and
(f) comparing the output scores from the first and second timepoints to determine the change in symptom intensity.

In the above method, the first timepoint occurs before treatment for venous insufficiency has occurred and the second timepoint occurs after treatment has occurred.

Accordingly the present invention provides a computer system for indicating to an individual potentially suffering from venous insufficiency, that they should seek diagnosis or treatment from a physician for venous insufficiency, comprising
an output device for providing a series of questions to the individual relating to one or more symptoms of varicose veins wherein each question has a score;
an input device to record the patients answers to said questions;
a processor to calculate the total score based on the patients answers and to determine if the total score is greater than x; and
an output device to inform the individual they should seek diagnosis or treatment from a physician if the score is greater than x; and
an output device to inform the individual they should not seek diagnosis or treatment from the physician if the score is less than x.

Accordingly the present invention provides a computer system for indicating to an individual potentially suffering from venous insufficiency, that they should seek diagnosis or treatment from a physician for venous insufficiency, comprising
an output device for providing a series of questions to the individual relating to one or more symptoms of varicose veins wherein each question has a score;
an input device to record the patients answers to said questions;
a processor to calculate the total score based on the patients answers; and
an output device to provide a message for the individual's physician based on the score.

Accordingly the present invention provides a computer system for use by an individual to determine eligibility for treatment of venous insufficiency comprising:
an output device that administers a group of questions to the individual wherein each of said questions relate to one or more symptoms of varicose veins and wherein each question is assigned a predetermined weight;
a processor that calculates an output score based on the individual's answers to each of the questions and the predetermined weight of the question;
an algorithm that determines an eligibility score based on the output score; and
wherein the display provides the individual with a recommended course of action for the treatment of venous insufficiency.

Any of the computer systems can include an output device that is audible, visual, or tactile. Any of the computer systems can include n input device that is audible, visual or tactile. Any of the

The computer systems can be internet or cloud based.

As used herein the following terms have the following definitions:

“Input device” means anything which is audible, visual or tactile such as microphones, television screens, computer screens, touchscreens, mobile phone screens, including mobile phone applications, keypads, keyboards and the like
“Output device” means anything audible, visual or tactile such as speakers, television screens, computer screens, touchscreens, mobile phone screens, including mobile phone applications, keypads, keyboards and the like, which provides the output from the method/devices
“display” means any medium on which the inputs and/or the final scores can be displayed
“processor” means any computer or computing device including a calculator. In addition, processing can be performed by suitable means including including pen and paper and mental calculations.

The inventors have established that particular subsets of symptoms associated with varicose veins are useful and reliable in assessing clinical severity of venous insufficiency and as such may be used to predict or monitor efficacy of a chosen treatment. Information regarding the intensity or the duration of the symptoms identified may be used to create a score, which is predictive of venous insufficiency and may be used to predict efficacy of a particular treatment. Provided at least 4 of the symptoms, and preferably at least 5, 7 or 9 of the symptoms are measured in terms of duration of symptoms or intensity of symptoms on a standardized score, severity of symptoms may be assessed in a more robust and reproducible manner than is available from current PRO measures.

As used herein “varicose veins”, “venous incompetence”, “venous insufficiency” and “venous disorder” are intended to have the same meaning and to generally describe the disease states classified by the CEAP classification system.

The group of symptoms consist of the following: heavy legs (or heaviness), aching (or achiness), swelling, night cramps, restlessness, heat or burning sensation, throbbing, itching, and tingling sensation and are conveniently measured using a duration scale of 0 (no symptoms) to 5 (symptoms experienced all the time) or an intensity scale of from 0 to 10 where o represents no symptoms and 10 represents as bad as can be imagined. Information regarding the symptoms are recorded in the form of answers to questions regarding the duration or intensity of the symptoms. Additional questions regarding patient activity or inactivity or quality of life may be asked in addition to questions regarding the symptoms. Questions may be asked in any suitable form that conveys the information to the individual or the patient, for example, paper or television screen, hand-held portable electronic device, computer screen, orally or aurally. Similarly the answers to the questions may be recorded by any suitable device which is able to record the information (either permanently or in a transient manner). Questions and answers may conveniently be recorded in a standard paper format or using a daily electronic diary.

Conveniently daily recording allows scores to be collected and averaged over a fixed time period, such as 1, 2, 3, 4, 5, 6 0r 7 days.

As is evidenced below the output score of the method and devices of the invention whether 5, 6, 7, 8 or 9 symptoms are measured (either in terms of intensity of duration) is robust and highly reproducible. In a particular embodiment a subset of 5 symptoms measured on a duration scale provides a score which is more predictive than other combinations of the well known symptoms, when measured in terms of Effect Size.

Comparison of Effect Size as Change from Baseline at
Week 8 (LOCF pooled PEM) Across Symptom Measures
Raw Mean

| | “VANISH 1” Study 015 | | | “VANISH 2” Study 016 | | |
|---|---|---|---|---|---|---|
| | | | Effect | | | Effect |
| Symptom Measures | Mean | SD | Size | Mean | SD | Size |
| VVSymQ i.e. 5 | −5.52 | 4.41 | −1.25 | −5.39 | 4.23 | −1.27 |
| symptoms (HASTI) | | | | | | |
| Duration (e-diary) | | | | | | |
| VVSymQ 5 | −7.26 | 4.97 | −1.46 | −7.15 | 4.91 | −1.46 |
| symptoms | | | | | | |
| duration (paper) | | | | | | |
| 7 Symptoms | −7.17 | 5.97 | −1.20 | −7.01 | 5.87 | −1.19 |
| Duration | | | | | | |
| 9 Symptoms | −8.67 | 7.30 | −1.19 | −8.48 | 7.29 | −1.16 |
| Duration | | | | | | |
| 5 Symptoms | −11.61 | 10.05 | −1.15 | −11.46 | 10.39 | −1.10 |
| Intensity | | | | | | |
| 7 Symptoms | −15.32 | 13.64 | −1.12 | −14.88 | 14.44 | −1.03 |
| Intensity | | | | | | |
| 9 Symptoms | −18.67 | 16.85 | −1.11 | −18.32 | 18.14 | −1.01 |
| Intensity | | | | | | |

5 symptoms = heaviness, achiness, swelling, throbbing, itching
VVSymQ score based on 5 symptoms measure on an duration scale where 0 = none of the time and 5 = all of the time

A paper and electronic (hand-held portable device) version of the instrument embodying the method of the invention was used in two phase 3 studies of polidocanol endovenous microfoam (PEM)—a treatment for chronic venous insufficiency—which was undertaken with the goal of obtaining marketing approval from the US Food and Drug Administration (FDA) for the comprehensive treatment of symptoms and appearance associated with varicose veins caused by saphenofemoral junction (SFJ) incompetence.

The clinical trial was a randomized, blinded, multicenter trial. Improvement of symptoms (as measured using the instrument of the present invention) and improvement of appearance were the primary and secondary endpoints of the study, respectively. In particular, and as described below, a method and instrument in which individual scores were weighted towards 5 symptoms (heaviness, achiness, swelling, throbbing and itching) on a duration scale was validated and then used in the trial.

PEM was developed through multiple preclinical and clinical trials (>1300 patients treated) and delivers pharmaceutical grade, low density sterile polidocanol injectable microfoam from a proprietary canister system. The gas mixture used to generate PEM is a precisely controlled ratio of oxygen and carbon dioxide (65:35), with low nitrogen content and provides a microfoam of defined density, bubble size distribution and half-separation time (a measure of stability) with no bubbles greater than 500 μm. These physio-chemical properties enable efficient delivery of sclerosant to the venous endothelium. PEM has been shown to be safe in the at-risk population with a right-to-left shunt, predominantly patent foramen ovale.

Comparison of treatment options for superficial venous disease may be constrained by the choice of study design and endpoints used in published clinical trials. Clinical studies are classified hierarchically according to grades of evidence on the basis of research design and internal validity, with blinded, randomized controlled trials having the highest value. Most studies of varicose vein treatments have been conducted as single-center case series, rather than blinded randomized controlled trials, potentially limiting the applicability of the results. The use of duplex closure rate as an endpoint adds a further limitation in that it is a surrogate endpoint and not a direct measure of patient benefit. The FDA is reluctant to grant marketing approval for drugs evaluated with surrogate endpoints, preferring measures of how patients feel, function or survive. Such endpoints present their own unique challenges, and the FDA has issued detailed guidance on the design, validation and use of PROs.

The evaluation of foam sclerosants is complicated further by the lack of standardization in their preparation, there are currently no approved foam sclerosants in the United States. Physician-compounded sclerosant foam is widely used, and was found to be relatively safe in a large reported series. However, there are multiple reports of rare but significant neurologic events occurring after the injection of air-based foam preparations.

The current study was designed to avoid previous limitations of trial design, choice of endpoint and issues of foam specification and consistency.

Validation of Daily Diary for Varicose Vein Symptoms and Activity

The Daily Diary for Varicose Vein Symptoms and Activity (a 20-item Evening Report administered on paper and as a daily electronic diary), for brevity hereafter referred to as the ‘Daily Diary’, included the following symptoms:
1. Heaviness
2. Achiness
3. Swelling
4. Throbbing
5. Itching
6. Heat or burning sensation
7. Tingling sensation
8. Night cramps
9. Restless legs

Each symptom was rated once for duration, and once for intensity.

Duration was assessed “since waking up today” for symptoms 1-7, and “last night” for symptoms 8 and 9. A six point scale, was used, as follows
0: None of the time
1: A little of the time
2: Some of the time
3: A good bit of the time
4: Most of the time
5: All of the time

Intensity was assessed using a 0-10 point numeric rating scale where 0 was labelled “None” and 10 was labelled “As bad as you can imagine”

Patients were also asked to respond to the questions “Please select your overall activity level since waking up today” and “How much of the time have you spent sitting or standing without moving around since waking up today?” Patients responded to these questions by selecting one item from a six-point scale (i.e., no activity, a little activity, some activity, a good bit of activity, a lot of activity, or extreme activity for the first question, and none of the time, a little of the time, some of the time, a good bit of the time, most of the time or all of the time for the second question). Taken together, the 20-items in the Evening Report are referred within this report as the Daily Diary for Varicose Vein Symptoms and Activity.

The following summary scores were derived from the electronic Daily Diary scores:
5-item duration: Sum of items 1-5 (Range 0-25)
7-item duration: Sum of items 1-7 (0-35)
9-item duration: Sum of items 1-9 (0-45)
5-item intensity: Sum of items 1-5 (Range 0-50)
7-item intensity: Sum of items 1-7 (0-70)
9-item intensity: Sum of items 1-9 (0-90)

Forty two patients were screened for the study, and of these 40 were enrolled. The two patients who were not enrolled scored <7 points on a screening application of the questionnaire at a first visit. For screening, a 5 item duration score was applied i.e. where the score relating to symptoms 1-5 on a duration scale were used to determine a score. As will each of the embodiments herein, where 5 items were measured the weighting applied to all of the questions was that a zero score was applied to all answers other than the 5 items, to which the patient score was used, as described above. to All 40 enrolled patients completed the study. The patient sample was representative of a typical varicose vein population, with more females seeking treatment (62.5%), and patients reporting at least moderately severe varicose vein symptom according to the established VCSS There was no bias towards one or the other leg to be treated. Compliance with completion of the Daily Diary was extremely high, with over 97% of scheduled entries completed for each of the three assessment periods (Screening, Baseline, and Post-treatment).

To that end, the Baseline correlations were computed for different configurations of the Daily Diary, as shown in Table 7. Of most relevance are the correlations between the 5-item duration Score (“VVSymQ”) with the 7, 9 item duration scores, and the corresponding 5, 7, and 9 items intensity scores. As shown in Table 7, these range from 0.9105 to 0.9802. These extremely high correlations suggest that the various configurations of the Daily Diary summaries are highly concordant, which in turn supports the use of the output score as reflecting the patient's overall symptom experience.

These results are further supported by correlations of the change between Baseline and Post-Treatment (Week 8), between the various configurations of the Daily Diary (Table 8). These correlations ranged from 0.8862 to 0.9790, again suggesting high levels of concordance between the changes that occurred between Baseline and Week 8 regardless of the summary score used to compute the change. These data further support the 5 item duration score as an appropriate measure of the patient's overall symptom experience.

A formal assessment of stability of patients' reporting of symptoms is the computation of reliability estimates. Reliability of patients' symptoms as reported in the Daily Diary was evaluated through the analysis of day to day variability in reporting, and also by comparing week to week reporting between Screening and Baseline, when the underlying condition was expected to be stable.

The agreement between items from one day to the next was very high for the VVSymQ score (5-item duration), The scale range for the VVSymQ score is 0 to 25, and the range of mean scores was approximately 6 units. When mean scores for Days −7 to −2 are compared with the mean score for Day −1, the modal deviation is 1 scale unit in all cases. There was little or no tendency for scores to differ more markedly, as assessed by absolute agreement, kappa values, or ICC, when separated by greater time-intervals (e.g. there was little or no difference between the Day −2/−1 comparison and the Day −7/−1 comparison). Similar results were observed when each of the daily scores was compared to the mean score of Days 1-7. Scores for Days −14 to −8 showed only slightly less agreement with Day −1 than did scores for Days −7 to −1.

The test re-test, or week to week, reliability (from Screening to Baseline) was also computed. The intraclass correlation coefficient (ICC) of the comparison between the mean VVSymQ score for Baseline (Days −14 to −8) and Screening (Days −7 to −1) was 0.96, which indicates excellent re-test reliability. Values of 0.75 or higher for ICCs are generally considered satisfactory.

Finally, internal consistency, that is the consistency among responses to the items within the Daily Diary, was also assessed. The estimates used for internal consistency are Cronbach's alphas. Internal consistency was confirmed for three different configurations of the Daily Diary, all 9 items, 7 of the 9 items, and the 5 items (duration response scale). Cronbach's alpha values for correlations between the 7-day average VVSymQ score and all of the other Daily Diary item scale scores configurations were >0.7, indicating good scale consistency (Nunnally, 1994). Post-Treatment Cronbach's alpha values for correlations between the electronic Daily Diary scores were lower than those for the Screening and Baseline. This is to be expected, given the lower incidence of symptoms following treatment. When values were corrected for number of items using the Spearman-Brown formula, there was no evidence that the number of items in the scale influenced the Cronbach's alpha values. The similarity of the Cronbach alpha values across the configurations indicates that whether 5, 7, or 9 items are used to characterize symptoms in patients, there will be a high level of internal consistency in the results.

The ability for the Daily Diary items, and specifically the VVSymQ, to detect change was evaluated by comparing Baseline and Post-Treatment (Week 8), time points.

At Week 8 relatively large reductions (improvement) as symptoms went from a mean of approximately 1.5 (range 0.6-1.9) to a mean of approximately 0.4 for the duration response scale. This represents a large relative reduction that is reflected in the calculated effect sizes shown above. Effect size (ES; i.e., the change in mean value from Baseline to Week 8, expressed as a proportion of the standard deviation of the Baseline pre-treatment scores), were large for the VVSymQ (1.6). Cohen (1988) suggested thresholds of 0.2, 0.5 and 0.8 for small, moderate and large effect sizes. In this study, even the smallest effect sizes found i.e. 1.2, would be considered large. This indicates that the type of changes expected in treating this general patient population with varicose veins can be sensitively detected with the instruments used in the current study, and, in particular the 5 item duration measurement.

Nevertheless, regardless of whether 5, 7, or 9 items were examined on either the duration or intensity response scales, the effect sizes ranged from 1.3-1.6, with the VVSymQ having the largest effect size. This indicates that change in symptoms from treatment can be sensitively detected by virtually any configuration of the Daily Diary items.

### EXAMPLE

### Use in a Clinical Trial

### Design

The instrument was used in an on-going, five-year, randomized, multicenter, parallel-group study designed to evaluate the efficacy and safety of two concentrations of PEM (0.5% and 1.0%), administered in a double-blind manner, compared with placebo, administered in a single-blind manner. It was not possible to blind the study site staff to patient treatment with the placebo due to visual differences with the anticipated therapeutic doses (0.5% and 1.0%) of PEM. Therefore, the PEM study treatment groups were double-blinded by including a sub-therapeutic PEM 0.125% control dose. PEM 0.125% is the lowest concentration of polidocanol solution that produces microfoam that is indistinguishable from the anticipated therapeutic doses; therefore, it served as a control for the duplex ultrasound endpoint where the vascular sonographer might be unblinded to active or placebo assignment. This report presents data on all patients through the primary efficacy endpoint at Week 8; all patients will be followed to 1 year, and to 5 years for those who consent to be followed. Documentation of adverse events (AEs) began after a patient provided written informed consent and continued until Week 8 (study endpoint) or 1 month later if the patient received optional open-label PEM 1.0%. AEs were defined as any untoward medical occurrences in a patient administered a pharmaceutical product, including those occurrences that did not necessarily have a causal relationship with the treatment.

### Population

The study population consisted of male and female patients aged 18 to 75 years who had SFJ incompetence (SFJ reflux >0.5 second), due to reflux of the GSV or major accessory veins as determined by duplex ultrasound, and superficial venous disease manifested by symptoms and visible varicosities. There was no maximum limit for GSV diameter, which was measured standing. Additionally patients needed to be able to reliably complete the electronic diary and meet other study requirements. Notable exclusion criteria included patients with a history of deep vein thrombosis or pulmonary embolism; inability to comply with post-treatment compression due to severe peripheral arterial disease or leg obesity; incompetence of the small saphenous vein, deep venous reflux or reduced mobility; or major surgery, pregnancy, or prolonged hospitalization within 3 months. Patients with only telangiectasia or reticular veins (CEAP clinical class C1) were also excluded. No concomitant medications were excluded.

### Ethics

This study was conducted under, and in compliance with, the principles of the International Conference on Harmonisation Good Clinical Practice and the Declaration of Helsinki (1996). The protocol and all associated materials were approved by a central institutional review board (IRB; Schulman Associates IRB, Cincinnati, Ohio, USA) or local IRBs. All patients provided written informed consent. This trial is registered on www.clinicaltrials.gov no. NCT01231373.

### Randomization

Patients who met the study entry criteria were randomized equally to one of four groups: PEM 0.5%, PEM 1.0%, PEM 0.125% control, or placebo. Randomization was stratified by baseline symptom score and by site, using an automated interactive voice recognition system (IVRS; United BioSource Corporation/Bracket, San Francisco, Calif., USA).

### Treatment

All patients underwent an initial blinded treatment session in which they received their assigned study drug. At the week 1 follow-up visit, if the initial treatment was unsuccessful or incomplete, patients could receive an optional, additional treatment with blinded study drug from the same PEM canister. After completion of all assessments for the primary endpoint at Week 8, patients with unsuccessful or incomplete treatment or residual visible varicosities could receive one or two optional, open-label treatments with 1.0% PEM, one week apart using the same PEM canister.

At each treatment session, a maximum volume of 15 mL of study drug (in 5-mL aliquots) was allowed regardless of treatment assignment. For the blinded treatment sessions, all dose-concentrations of PEM were in identical canisters identified only by a numeric code; the code for a given patient was assigned by the Interactive Voice Recognition System (IVRS). Placebo (agitated diluent solution) was prepared immediately prior to injection. To maintain patient blinding, the study drug was prepared outside of the treatment room, patients were physically blocked from viewing the procedure using screening or drapes and study staff were instructed to use ‘study drug’ terms when referring to either PEM or placebo. The vein to be treated (either the GSV or an accessory saphenous vein) was cannulated at the mid-thigh under ultrasound guidance. The initial 5 mL of study drug was injected proximally under ultrasound guidance from the site of the cannulation to a point 5 cm distal to the SFJ. Additional study drug was injected distally to fill the distal GSV and visible varicose tributaries. The treated leg was wrapped in a limited-stretch bandage with compression pads placed over the treated venous segments. An overstocking and thigh-length 30- to 40-mm Hg compression stocking (Venosan North America, Asheboro, N.C., USA) was placed over the dressing. The compression bandages and stocking were worn continuously for the first at 48 hours and the compression stocking only was worn day and night for an additional 12 days. Patients were mobilized as soon as the treatment was complete and were encouraged to walk for at least five minutes during each waking hour for the week following treatment.

### Safety Follow-Up

At each study visit after the initial treatment, AEs, concomitant medications and procedures were recorded. One week after each study treatment (initial or optional additional treatment) patients had a follow-up visit for safety using duplex ultrasound. Detailed per-protocol duplex ultrasound assessments were completed of the deep veins using repeated compression and color flow from the malleoli upwards at regular intervals. All thrombi that were detected, in the deep and muscular calf veins were reported, as were all extensions of thrombus from the SFJ into the common femoral vein (Common Femoral Vein Thrombus Extension; CFVTE). If a thrombus AE was identified, patients underwent an additional duplex scan one and two weeks later and then monthly until the thrombi stabilized or resolved. The patient was evaluated for the presence of symptoms of venous thrombus and of pulmonary embolism. Management of the identified thrombi was according to clinical presentation and usual clinical practice; recommendations consistent with the American College of Chest Physicians guidelines were provided for anticoagulation. All venous thrombus events were reviewed by BTG and by an independent safety review board, which met at least every six months during the trial.

### Endpoints

### Primary Endpoint: Symptoms

The primary efficacy endpoint of this study was the patient-reported improvement in symptoms, as measured by the change from baseline to Week 8 in the 7-day average electronic daily diary score, calculated using a 5 item duration score output using symptoms 1-5 as described above. Items 1 to 5 were given the score corresponding to the answer given by the patient whereas the answers to all other questions were weighted to zero (in the same way as the scores were calculated in the validation study). Questions were presented and answers were collected using an electronic diary (modified Palm handheld device; invivodata, Inc., [now ERT], Pittsburgh, Pa., USA), patients completed an evening report (ER) on each of 10 days preceding the treatment day (baseline), Week 4 and Week 8 visits, and ERs were automatically transmitted to a secure central database. The ER consisted of 20 questions regarding varicose vein symptoms, of which five pre-specified symptoms contributed to the output score as described above. In this embodiment, each of the five symptoms (HASTI) was assessed on a six point duration scale—from 0 (none of the time) to 5 (all of the time)—and added together to generate a daily symptom score of 0 to 25. These daily scores were averaged for the seven most recent days prior to each study visit; a minimum of four daily reports was required to calculate an average score. Each eligible patient was trained in the use of the electronic diary, and compliance was monitored remotely by web report.

Clinically Meaningful Change To evaluate whether the changes observed with treatment were clinically meaningful, patients completed a Global Impression of Change (PGICs) questionnaire for symptoms and for appearance at Weeks 4 and 8. Similarly, an independent panellist completed a clinician global impression of change (CGIC) for appearance at Week 8. Both the PGIC and CGIC used a 7-point scale to report the overall patient benefit (or decline) following treatment. For each global assessment, a clinically meaningful change was defined as the percent of patients whose symptoms (or appearance) had “moderately improved” or “much improved”.
Tertiary Endpoints The three tertiary efficacy endpoints of this study were response to treatment as determined by duplex ultrasound, improvement in Venous Clinical Severity Score (VCSS) and improvement in the modified Venous Insufficiency Epidemiological and Economic Study-Quality of Life (VEINES-QOL) score; all were assessed at Week 8. Response to treatment, as determined by duplex ultrasound, was defined as the elimination of reflux through the SFJ and/or complete occlusion of the target vein(s) (incompetent GSV and/or major accessory vein).

### Statistics

Calculated sample size was based on a pilot study. Sample size was selected to provide 95% power to detect an absolute difference of 3 (0 to 25 scale) between pooled PEM 0.5% and 1% arms versus placebo. Approximately 228 treated patients (57 per treatment group) were needed to obtain 204 patients (51 per treatment group) evaluable for the primary efficacy endpoint analysis. All endpoints were tested in strict hierarchical order with alpha set at 0.05, each subsequent test only being undertaken if statistical significance was achieved for the previous endpoints thereby controlling type I error.

### Results

### Patients

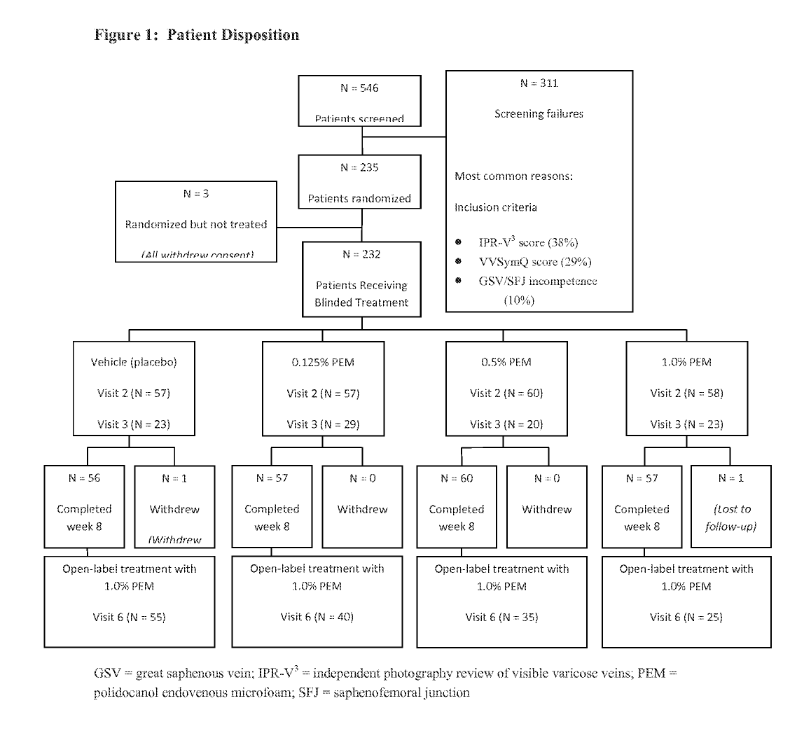

Five hundred forty-six patients were screened at 14 US study sites, 235 patients were randomized and 232 patients were treated with PEM 0.5% (n=60), PEM 1.0% (n=58), placebo (n=57) or PEM 0.125% control (n=57); 230 patients completed Week 8, the primary study time point. Patient disposition is detailed in FIG. 1.

### Demographics

Patients were typical of the varicose vein population, and there were no clinically meaningful differences in baseline characteristics between treatment groups (Table 1). CEAP clinical class distribution was 31.9% C2, 40.1% C3, 22.8% C4, 5.2% C5/C6. GSV reflux was present in 87.1% of patients, mean GSV diameter was 8.7 mm (range 3.1-19.4 mm).

### Treatments

All randomized patients received their allocated treatment. Mean total volumes were 13.3 mL of PEM 0.5%, 12.4 mL of PEM 1.0% and 8.3 mL of placebo. Additional treatment was administered one week later to 35% and 40% of patients treated with PEM 0.5% (n=21) and PEM 1.0% (n=23) respectively. In these 44 patients, only 3 patients received an additional treatment to retreat veins that were treated at the initial treatment session (PEM 0.5%, n=1; PEM 1.0%, n=2). The remaining 41 patients had veins treated that were not treated in the initial session. Overall, PEM 0.5% and 1.0% patients received on average 1.4 blinded treatments.

### Improvement of Symptoms

At 4 and 8 weeks there were highly statistically significant improvements in output scores for both the 0.5% PEM and 1.0% PEM groups compared with the placebo group; these improvements with both treatments were clinically meaningful to patients at both time points. (P<0.0001 for all measures) (Table 2). Overall, there was a 64% reduction in symptom burden in the pooled group compared to 22% for placebo. Additionally, treatment with PEM was superior to placebo in improving symptoms when either a duration or intensity scale was used to measure patients' symptoms, and irrespective of whether an additional 4 symptoms were measured. The improvement in symptoms was supported by highly statistically significant results in the established VCSS questionnaire and VEINES-QOL score (Table 3).

### Blinding

Blinding was highly effective. On the day of treatment, 85% (196/230) of patients did not think they knew the treatment they had received; of the 34 who thought they knew, 20 (8.7% of all patients treated) correctly guessed their treatment.

### Duplex Ultrasound Response

A duplex responder was defined as a patient with elimination of SFJ reflux and/or complete occlusion of the GSV and/or accessory veins that were identified as incompetent at baseline. This was achieved in 83% and 86% of patients receiving 0.5% PEM and 1.0% PEM, respectively, compared with 0.125% blinded control of 60% (p<0.005 and p<0.001), and only 2% of patients who received placebo (Table 3). GSV diameter had little effect on duplex response rates (90%, 100%, 84%, 77%, and 79% response with increasing vein diameters: <5 mm, 5-<7, 7-<10, 10-<12 and >12 mm).

### Discussion

This was the first of two pivotal phase 3 trials to compare the efficacy of two concentrations of a proprietary pharmaceutical-grade polidocanol injectable microfoam-PEM 0.5%, PEM 1.0%—compared with placebo as part of an FDA investigational new drug application. The efficacy endpoints were assessed using the method and device of the invention which were developed to be ‘fit-for purpose’ following FDA guidelines; instrument development work demonstrated content validity, reliability and the ability to demonstrate a treatment effect.

In this study, demographic characteristics including CEAP classification of the patients were typical of a U.S. varicose vein population, and GSV diameters up to 19.6 mm were treated. Overall, patients received an average of 1.4 blinded treatments with PEM to comprehensively treat the GSV, accessory veins and varicosities.

The primary endpoint assessed daily symptom burden using an electronic diary. Patient compliance with completing the daily diary was excellent, exceeding 85% for each visit, suggesting that the symptoms measure was easy for individuals to complete. Improvement in symptoms using the methods and instruments of the present invention demonstrated that efficacy with PEM 0.5% and 1.0% is robust and statistically superior to placebo, regardless of whether a duration or intensity scale was used to measure patients' symptoms, and irrespective of whether an additional 4 symptoms were measured.

Importantly, the improvements in symptoms were demonstrated to be clinically meaningful to the patients. The results reported are of efficacy at 8 weeks, and longer term results will assess the durability of benefit at 1 year and out to 5 years.

Changes in the magnitude and direction in the output scores in this study were shown to be consistent with changes in VCSS and VEINES-QOL scores; correlations between these measures were moderately strong, illustrating that the instruments measured different aspects of the same disease.

Because the FDA considers ultrasound-identified venous closure to be a surrogate endpoint and not a measure of patient benefit, it served only as a tertiary endpoint in this study. A more rigorous duplex responder definition than typically applied was used in this design. There was a weak correlation between this duplex response criteria and patient symptoms as assessed by VVSymQ (correlation coefficient: 0.26), primarily because symptom improvement was demonstrated in both duplex responder and non-responders.

### CONCLUSION

This study demonstrates that PEM 0.5% and 1.0% treatment of the GSV system is effective and provides clinically meaningful benefit in treating the symptoms and appearance of varicose veins at the primary endpoint at 8 weeks. Efficacy was demonstrated by measuring the change inpatient symptoms using the method and devices of the present invention which were confirmed by improvement in appearance from the patient perspective as well as duplex response and clinical severity (VCSS) as assessed by the study investigator and disease-related quality of life (VEINES-QOL) as assessed by the patient. The methods, devices and instruments described herein provide an important, new validated instrument for symptom assessment in patients with varicose veins.

TABLE 1
Patient Demographics

| | | PEM 0.125% | PEM | PEM | All |
|---|---|---|---|---|---|
| | Placebo | Control | 0.5% | 1.0% | Patients |
| | (n = 57) | (n = 57) | (n = 60) | (n = 58) | (N = 232) |
| Age, years (mean) | 49.8 | 52.8 | 50.4 | 50.0 | 50.8 |
| (min, max) | (30.72) | (25.73) | (31.71) | (21.70) | (21.73) |
| Sex, female | 73.7% | 75.4% | 66.7% | 75.9% | 72.8% |
| Race, white | 94.7% | 93.0% | 91.7% | 91.4% | 92.7% |
| BMI, kg/m² (mean) | 28.8 | 30.1 | 30.7 | 28.4 | 29.5 |
| GSV diameter, mm | 8.3 | 8.5 | 9.0 | 9.0 | 8.7 |
| (mean) | | | | | |
| CEAP Class | | | | | |
| C2 (varicose veins) | 35.1% | 22.8% | 35.0% | 34.5% | 31.9% |
| C3 (edema | 38.6% | 52.6% | 31.7% | 37.9% | 40.1% |
| C4 (skin changes) | 17.5% | 19.3% | 30.0% | 24.1% | 22.8% |
| C5 and C6 (healed; | 8.8% | 5.3% | 3.3% | 3.4% | 5.2% |
| active ulcers) | | | | | |

BMI = body mass index;
CEAP = Clinical, Etiology, Anatomy, Pathophysiology;
GSV = great saphenous vein;
PEM = polidocanol endovenous microfoam.

TABLE 2
Improvement in Symptoms of Varicose Veins as
Measured by VVSymQ at Week 4 and Week 8

| | VVSymQ | | | |
|---|---|---|---|---|
| | | | | Pooled |
| | | | | PEM |
| | | PEM | PEM | (0.5% and |
| | Placebo | 0.5% | 1.0% | 1.0%) |
| N | 54 | 60 | 57 | 117 |
| Baseline Score, mean | 9.26 | 9.48 | 7.82 | 8.67 |
| Adjusted Mean Change | −1.99 | −5.40 | −4.88 | −5.14 |
| from Baseline at Week 4 | | | | |
| Clinically meaningful | 19.6% | 78.3% | 72.4% | 75.4% |
| improvement in | (n = 56) | (n = 60) | (n = 58) | (n = 118) |
| Symptoms at Week 4** | | | | |
| Adjusted Mean Change | −2.00 | −6.01 | −5.06 | −5.53 |
| from baseline at Week 8 | | | | |
| Clinically meaningful | 19.6% | 83.3% | 75.9% | 79.7% |
| improvement in | (n = 56) | (n = 60) | (n = 58) | (n = 118) |
| Symptoms at Week 8** | | | | |
| Comparison vs. Placebo | | <0.0001 | <0.0001 | <0.0001 |
| at Week 8, P-value, | | | | |
| Adjusted Mean Change | | | | |

*N is the number of patients with both a baseline value and a value at the corresponding visit.
Note:
On the VVSymQ Mstrument, lower scores and/or negative change scores indicate better outcomes.

TABLE 3
Tertiary Endpoints, Response to Treatment as Measured by Duplex
Ultrasound, VCSS and VEINES-QOL at Week 8
Duplex Response

| | | | | | Pooled |
|---|---|---|---|---|---|
| | | | | | PEM |
| | | PEM | | | (0.5% |
| | | 0.125% | PEM | PEM | and |
| | Placebo | Control | 0.5% | 1.0% | 1.0%) |
| n | 56 | 57 | 60 | 58 | 118 |
| Responders | 1.8% | 59.6% | 83.3% | 86.2% | 84.7% |
| Comparison vs. | n/a | | 0.0043 | 0.0009 | 0.0002 |
| PEM 0.125% | | | | | |
| Control at | | | | | |
| Week 8, | | | | | |
| P-value | | | | | |

VCSS

| | | | | Pooled |
|---|---|---|---|---|
| | | | | PEM |
| | | | | (0.5% |
| | | PEM | PEM | and |
| | Placebo | 0.5% | 1.0% | 1.0%) |
| n | 56 | 60 | 55 | 115 |
| Baseline Score, | 8.04 | 8.25 | 8.11 | 8.18 |
| mean | | | | |
| Adjusted | −1.52 | −5.15 | −5.05 | −5.10 |
| Mean Change | | | | |
| from Baseline | | | | |
| at Week 8 | | | | |
| Comparison vs, | | <0.0001 | <0.0001 | <0.0001 |
| Placebo at | | | | |
| Week 8, P-value | | | | |

VEINES-QOL

| | | | | Pooled |
|---|---|---|---|---|
| | | | | PEM |
| | | | | (0.5% |
| | | PEM | PEM | and |
| | Placebo | 0.5% | 1.0% | 1.0%) |
| n | 56 | 60 | 56 | 116 |
| Baseline Score, | 53.72 | 53.68 | 57.64 | 55.59 |
| mean | | | | |
| Adjusted | 7.42 | 22.79 | 20.42 | 21.60 |
| Mean Change | | | | |
| from Baseline | | | | |
| at Week 8 | | | | |
| Comparison vs. | | <0.0001 | <0.0001 | <0.0001 |
| Placebo at | | | | |
| Week 8, P-value | | | | |

Note:
On the VCSS instrument, lower scores and/or negative change scores indicate better outcomes.
Note:
On the VEINES-QOL instrument, higher scores andlor positive change scores indicate better outcomes.

TABLE 5
Treatment-emergent Adverse Events in ≧3% of Patients (Pooled PEM)

| | Blinded | | | | Open- | |
|---|---|---|---|---|---|---|
| | | PEM 0.125% | PEM | PEM | Label | |
| | Placebo | control | 0.5% | 1.0% | PEM 1.0% | Total PEM |
| Adverse Reaction | (N = 57) | (N = 57) | (N = 60) | (N = 58) | (N = 155) | (N = 230) |
| Pain in extremity | 10.5 | 12.3 | 5.0 | 15.5 | 7.7 | 13.5 |
| Retained coagulum | 0 | 10.5 | 11.7 | 27.6 | 18.1 | 20.9 |
| Limb discomfort | 3.5 | 1.8 | 3.3 | 5.2 | 0.6 | 2.6 |
| Common femoral | 0 | 3.5 | 3.3 | 6.9 | 0.6 | 3.9 |
| vein thrombus | | | | | | |
| extension* | | | | | | |
| Tenderness | 0 | 0 | 1.7 | 6.9 | 1.9 | 3.5 |
| Thrombophlebitis | 1.8 | 7.0 | 13.3 | 3.4 | 1.9 | 7.4 |
| superficial | | | | | | |
| Deep vein thrombosis | 0 | 0 | 0 | 8.6 | 5.2 | 5.7 |
| Injection site pain | 0 | 0 | 3.3 | 1.7 | 0 | 1.3 |
| Inflammation | 0 | 0 | 1.7 | 3.4 | 0 | 1.3 |
| Hematoma | 0 | 1.8 | 5.0 | 3.4 | 1.3 | 3.5 |
| Isolated | 0 | 3.5 | 0 | 0 | 0 | 0.9 |
| gastrocnemius and | | | | | | |
| Soleal venous | | | | | | |
| thrombus | | | | | | |

*Common femoral vein thrombus extension (non-occlusive thrombi starting in the superficial vein and extending into the common femoral vein).

TABLE 6
Patients with Venous Thrombus Adverse Events

| | | Blinded | | | | | |
|---|---|---|---|---|---|---|---|
| | | | PEM | | | Open- | |
| | | | 0.125%% | PEM | PEM | Label | Total |
| Adverse | | Placebo | control | 0.5% | 1.0% | PEM 1.0% | PEM |
| Reaction | | (N = 57) | (N = 57) | (N = 60) | (N = 58) | (n = 155) | (N = 230) |
| CFV Thrombus | | 0 (0%) | 2 (3.5%) | 2 (3.3%) | 4 (6.9%) | 1 (0.6) | 9 (3.9%) |
| Extension* | | | | | | | |
| DVT | Proximal | 0 (0%) | 0 (0%) | 0 (0%) | 3 (5.2%) | 3 (1.9) | 6 (2.6%) |
| | Distal | 0 (0%) | 0 (0%) | 0 (0%) | 2 (3.4%) | 5 (3.2) | 7 (3.0%) |

| | | | | | | |
|---|---|---|---|---|---|---|
| Isolated | 0 (0%) | 2 (3.5%) | 0 (0%) | 0 (0%) | 0 (0%) | 2 (0.9%) |
| Gastrocnemius | | | | | | |
| and Soleal | | | | | | |
| Venous | | | | | | |
| Thrombosis | | | | | | |

*Common femoral vein thrombus extension; (non-occlusive thrombi starting in the superficial vein and extending into the common femoral vein).

TABLE 7
Correlation between the 7 Day Average Diary VVSymQ Score
and Other Diary Assessments at Baseline for Study Population

| | Baseline | | | | | | |
|---|---|---|---|---|---|---|---|
| | 7-Day Average Score^{a} | | | | | | |
| | | | 7 Item | 9 Item | 5 Item | 7 Item | 9 Item |
| | VVSymQ | VVSymQ | (0-5) | (0-5) | (0-10) | (0-10) | (0-10) |
| Assessment | (Paper) | (Diary)^{b} | Duration^{c} | Duration^{d} | Intensity^{b} | Intensity^{c} | Intensity^{d} |
| VVSymQ (Paper) | 1.0000 | 0.8141*** | 0.8044*** | 0.7713*** | 0.8302*** | 0.8205*** | 0.7898*** |
| VVSymQ^{b} | | 1.0000 | 0.9802*** | 0.9511*** | 0.9453*** | 0.9324*** | 0.9105*** |
| 7-Item (0-5) Duration^{c} | | | 1.0000 | 0.9769*** | 0.9334*** | 0.9543*** | 0.9369*** |
| 9-Item (0-5) Duration^{d} | | | | 1.0000 | 0.9130*** | 0.9391*** | 0.9585*** |
| 5-Item (0-10) Intensity^{b} | | | | | 1.0000 | 0.9825*** | 0.9614*** |
| 7-Item (0-10) Intensity^{c} | | | | | | 1.0000 | 0.9844*** |
| 9-Item (0-10) Intensity^{d} | | | | | | | 1.0000 |

^{a}Days −7 to −1 from Diary.
^{b}Sum of 5 items: Heaviness, Achiness, Swelling, Throbbing and Itching.
^{c}Sum of 7 items: Heaviness, Achiness, Swelling, Throbbing, Itching, Heat or Burning Sensation, and Tingling Sensation.
^{d}Sum of 9 items: Heaviness, Achiness, Swelling, Throbbing, Itching, Heat or Burning Sensation, Tingling Sensation, Night Cramps, and Restless Legs.
*p ≦ 0.05;
**p ≦ 0.01;
***p ≦ 0.001
Note:
Table displays Pearson's Correlation Coefficients.

TABLE 1
Correlation of Changes at Week 8 Between 7 Day Average Diary VVSymQ
Score and Other Diary Symptom Summary Scores for Study Population

| | 7-Day Average Score^{a} | | | | | | |
|---|---|---|---|---|---|---|---|
| | | | 7 Item | 9 Item | 5 Item | 7 Item | 9 Item |
| | VVSymQ | VVSymQ | (0-5) | (0-5) | (0-10) | (0-10) | (0-10) |
| Assessment | (Paper) | (Diary)^{b} | Duration^{c} | Duration^{d} | Intensity^{b} | Intensity^{c} | Intensity^{d} |
| VVSymQ (Paper) | 1.0000 | 0.7545*** | 0.7346*** | 0.6981*** | 0.7917*** | 0.7709*** | 0.7377*** |
| VVSymQ^{b} | | 1.0000 | 0.9790*** | 0.9519*** | 0.9337*** | 0.9079*** | 0.8862*** |
| 7-Item (0-5) Duration^{c} | | | 1.0000 | 0.9785*** | 0.9279*** | 0.9397*** | 0.9226*** |
| 9-Item (0-5) Duration^{d} | | | | 1.0000 | 0.9029*** | 0.9248*** | 0.9421*** |
| 5-Item (0-10) intensity^{b} | | | | | 1.0000 | 0.9803*** | 0.9557*** |
| 7-Item (0-10) intensity^{c} | | | | | | 1.0000 | 0.9845*** |
| 9-Item (0-10) intensity^{d} | | | | | | | 1.0000 |

^{a}Days −7 to −1 from Diary.
^{b}Sum of 5 items: Heaviness, Achiness, Swelling, Throbbing and Itching.
^{c}Sum of 7 items: Heaviness, Achiness, Swelling, Throbbing, Itching, Heat or Burning Sensation, and Tingling Sensation.
^{d}Sum of 9 items: Heaviness, Achiness, Swelling, Throbbing, Itching, Heat or Burning Sensation, Tingling Sensation, Night Cramps, and Restless Legs.
*p ≦ 0.05;
**p ≦ 0.01;
***p ≦ 0.001
Note:
Table displays Pearson's Correlation Coefficients.

What is claimed is:

1. A method of determining eligibility for seeking medical intervention for the treatment of venous insufficiency comprising:
a) presenting a group of questions to an individual wherein each of said questions relate to one or more symptoms of varicose veins and wherein each question is assigned a predetermined weight;
b) providing a platform for the individual to answer the group of questions;
c) calculating an output score based on the individual's answers to each of the questions and the predetermined weight of the question;
d) analysing said output score to determine an eligibility of the individual for medical intervention; and
e) presenting the individual on the platform the individual's eligibility for medical intervention.
